(19) United States
(12) Patent Application Publication
(10) Pub. No.: US 2025/0284060 A1
(43) Pub. Date: Sep. 11, 2025

(54) OPTICAL DEVICE FOR AUGMENTED REALITY

(71) Applicant: Noble M & B Co., LTD, Yongin-si (KR)

(72) Inventors: Ki Tae Kim, Seoul (KR); Jihyung Roh, Suwon-si (KR); YeonPil Jung, Yongin-si (KR)

(73) Assignee: Noble M & B Co., LTD, Yongin-si (KR)

(21) Appl. No.: 18/631,064

(22) Filed: Apr. 10, 2024

(30) Foreign Application Priority Data
Mar. 5, 2024 (KR) 10-2024-0031022

(51) Int. Cl. G02B 6/26; G02B 27/01

(52) U.S. Cl. CPC G02B 6/262; G02B 27/0172

(57) ABSTRACT

An optical device for augmented reality, includes: a light generating unit for generating a first light; a first optical element for transmitting or reflecting an incident light according to an incident angle; a light guide for reflecting the incident light; and a second optical element formed with a predetermined slope and reflecting the incident light.

### CROSS-REFERENCE TO RELATED APPLICATION(S)

This application claims priority to Korean Patent Application No. 10-2024-0031022, filed on Mar. 5, 2024, the disclosure of which is incorporated herein by reference in its entirety.

### BACKGROUND OF THE INVENTION

### Technical Field

The present invention relates to an optical device for augmented reality.

### Description of the Related Art

In general, augmented reality (AR) is a field of virtual reality, and is a computer graphic technique that synthesizes virtual objects or information of an environment that actually exists to make them look like objects existing in an original environment.

In order to implement such augmented reality, a virtual image generated by a device such as a computer or an image is implemented by being superimposed on a real image using optical means such as a prism or the like that reflects or refracts a virtual image incident on a display by using optical means.

In an optical system using a beam splitter among devicees implementing the augmented reality, an augmented reality image is reflected by the beam splitter and reaches a user, and there is a limitation in reducing the size and weight of the optical system according to the beam splitter. There is a need to develop an optical system technology capable of reducing a weight to the level of general glasses and enabling a design by reducing a thickness (width) of an augmented reality lens while securing a sufficient Field of View (FOV) capable of solving such a problem.

### DESCRIPTION OF THE RELATED ART

### Document of Related Art

(Patent Document 0001) Korean Patent Registration No. 10-1660519 (2016 Sep. 29)

### SUMMARY OF THE INVENTION

The present invention has been made in an effort to provide an optical device for augmented reality with an improved thickness of the optical device for augmented reality.

An object of the present invention is to provide an optical device for augmented reality, which is capable of reducing weight by improving the thickness of the optical device while sufficiently securing a Field of View (FOV).

An object of the present invention is to provide an optical device for augmented reality with improved image quality of augmented reality.

An objective of the present invention is to provide an optical device for augmented reality in which a manufacturing process is simplified.

The objects of the present invention are not limited to the above-mentioned objects, and other objects not mentioned may be clearly understood by the skilled person in the art from the following description.

### Solution to Problem

According to an aspect of the present invention, there is provided an optical device for augmented reality, the optical device including: a light generating unit configured to generate a first light; a first optical element configured to transmit or reflect incident light according to an incident angle; a light guide configured to reflect the incident light; and a second optical element formed at a predetermined slope and configured to reflect the incident light, wherein the first light is incident on the first optical element and thus a transmitted second light is incident on the light guide, the second light is incident on the light guide and thus a reflected third light is incident on the second optical element, the third light is incident on the second optical element and thus a reflected fourth light is incident on the light guide, the fourth light is incident on the light guide and thus a reflected fifth light is incident on the first optical element, and the fifth light incident on the first optical element is reflected and thus incident on an eye of a user.

According to a configuration of the present disclosure, the first optical element may have a dielectric coating layer formed thereon.

According to an embodiment of the present disclosure, an incident angle at which the first light is incident on the first optical element may be smaller than an incident angle at which the fifth light is incident on the first optical element.

According to an embodiment of the present disclosure, an incident angle at which the first light is incident on the first optical element may be in a range of 0° to 45°.

According to an embodiment of the present disclosure, an incident angle at which the fifth light is incident on the first optical element may be in a range of 0° to 45°.

According to an embodiment of the present disclosure, the first optical element may be included to be inclined such that the first light is incident and transmitted to the first optical element at a predetermined incident angle and the fifth light is incident and reflected to the first optical element at a predetermined incident angle.

According to an embodiment of the present disclosure, the second optical element may be included to be inclined so that the third light is reflected and incident on the light guide.

### Effects of the Invention

According to an embodiment of the present disclosure, it is possible to provide an optical device for augmented reality in which the thickness of the optical device is improved while sufficiently securing a Field of View (FOV).

According to an embodiment of the present disclosure, it is possible to provide an optical device for implementing augmented reality in which the weight of the optical device is reduced by improving the thickness of the optical device.

According to a configuration of the present invention, it is possible to provide an optical device for implementing augmented reality with improved image quality of augmented reality.

According to an embodiment of the present disclosure, it is possible to provide an optical device for augmented reality in which a manufacturing process is simplified.

### BRIEF DESCRIPTION OF THE DRAWINGS

FIG. 1 is a view showing an optical device for augmented reality according to an exemplary embodiment of the present invention, FIG. 2 is a cross-sectional view taken along line A-A′ of the optical device for augmented reality of FIG. 1, FIGS. 3 and 4 are views showing transmission and reflection of light of the optical device for augmented reality according to an exemplary embodiment of the present invention, and FIG. 5 is a view showing transmission and reflection of light of the optical device for augmented reality according to an exemplary embodiment of the present invention.

### DETAILED DESCRIPTION OF THE INVENTION

Hereinafter, an embodiment of an optical device for augmented reality according to the present invention will be described in detail with reference to the accompanying drawings.

In adding reference numerals to elements of each drawing, it should be noted that the same feature elements are designated by the same reference numerals although they are shown in different drawings. Further, in describing the embodiments of the present invention, when it is determined that the detailed description of the related known feature or function interferes with the understanding of the embodiments of the present invention, the detailed description thereof will be omitted.

In describing components of the embodiments of the present invention, terms such as first, second, A, B, (a), (b), etc. may be used. The terms are used only to distinguish the components from other feature elements, and the nature, order, or sequence of the components is not limited by the terms. Further, unless otherwise defined, all terms used herein, including technical or scientific terms, have the same meaning as that generally understood by those skilled in the art. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

An augmented reality device provides augmented reality to a user. Here, the augmented reality is a real screen or a real image (hereinafter, referred to as a “real screen”) viewed by the user. It is a technology that superimposes and synthesizes virtual information such as text and graphics in real time on JPEG-D, JPEG-D, and JPEG-D, and displays a single image. The user may recognize the augmented reality by overlaying the augmented reality image provided by the augmented reality device on a reality screen that can be viewed by the augmented reality device and viewing the superimposed augmented reality image.

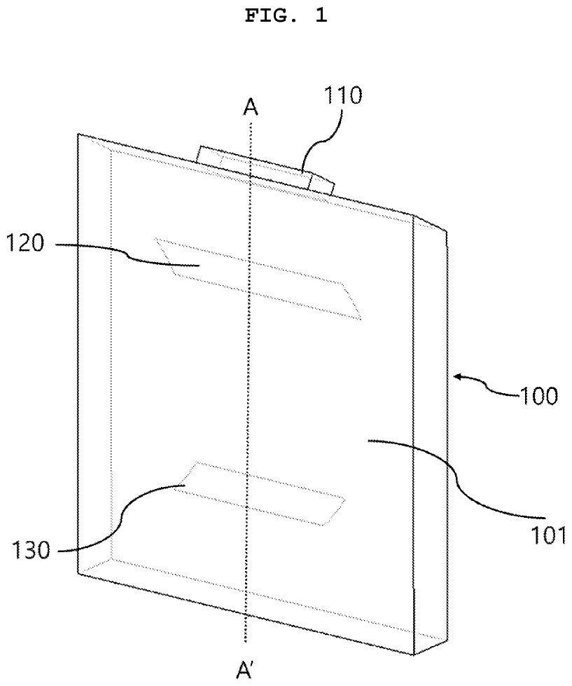

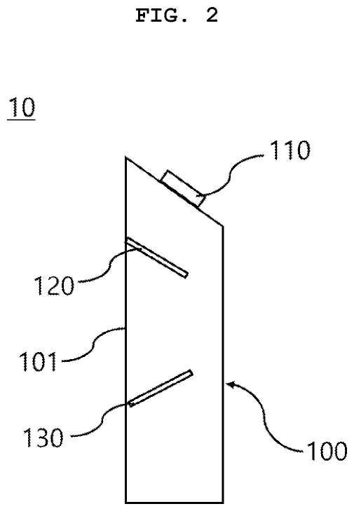

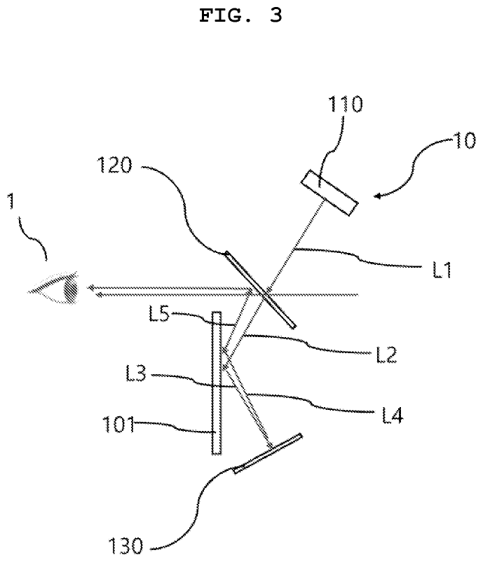

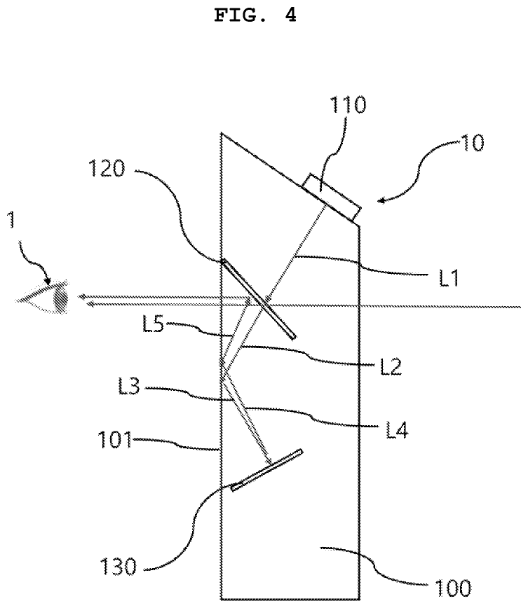

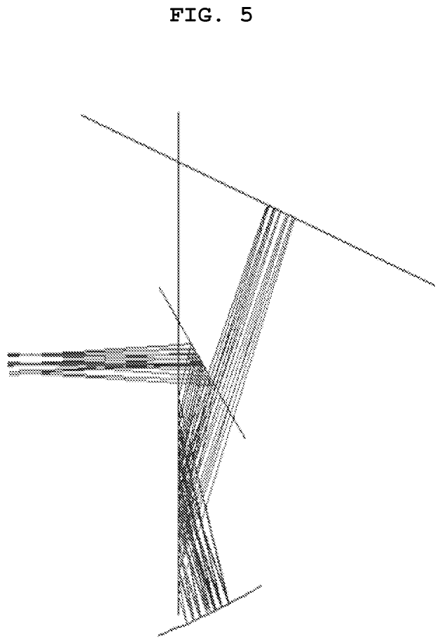

FIG. 1 is a view showing an optical device for augmented reality according to an exemplary embodiment of the present invention, FIG. 2 is a cross-sectional view taken along line A-A′ of the optical device for augmented reality of FIG. 1, and FIGS. 3 to 5 are views showing transmission and reflection of light of the optical device for augmented reality according to an exemplary embodiment of the present invention.

The optical device for augmented reality 10 according to FIGS. 1 to 5 may include a light generating unit 110 that generates a first light L1, a first optical element 120 that transmits or reflects incident light according to an incident angle, a light guide 101 that reflects the incident light, and a second optical element 130 that has a predetermined slope and reflects the incident light.

More specifically, the first light L1 generated and emitted from the light generating unit 110 may be incident on the first optical element 120. The first light L2 may be incident on t the first optical element 120, and the transmitted second light L2 may be incident on the light guide 101. A third light L3, which is the second light L2 incident on the light guide 101 and reflected therefrom, may be incident on the second optical element 130, and a fourth ((L4)) light, which is the third light L3 incident on the second optical element 130 and reflected therefrom, may be incident on the light guide. A fifth light L5 that the fourth light L4 is incident on the light guide 101 and reflected therefrom may be incident on the first optical element 120, and the fifth light L5 incident on the first optical element 120 may be reflected and incident on the user's eye, thereby implementing augmented reality.

Here, the light generated by the light generating unit 110 may refer to light that is transmitted and reflected to implement a character, an image, and a video on the user's eye 1. In addition, the user's eye 1 referred to in the present disclosure may preferably refer to the pupil of the user, but is not limited thereto.

The optical device for augmented reality 10 may include a light generating unit 110 that emits the first light L1. The light generating unit 110 may be included as a micro display that generates the first light L1, but is not limited thereto. Here, the micro display may emit light in which characters, images, and images including image information are implemented so that the image information may be provided to the user's eyes. The first light L1 emitted from the microdisplay may be incident on the first optical element 120 and transmitted.

Here, the light generating unit 110 may further include a collimator for collimating the first light L1 emitted from the microdisplay.

The optical device for augmented reality 10 may include a first optical element 120. The first light L1 generated by the light generating unit 110 may be incident on the first optical element 120. The first optical element 120 may be included to transmit or reflect light according to an incident angle, and the first light L1 generated and incident from the light generating unit 110 may be favorably transmitted to increase an amount of transmitted light, and the fifth light L5 incident from the light guide 101 may be inclined at a predetermined inclination to increase an amount of reflected light.

More specifically, the first optical element 120 may be included by being dielectric-coated. The first optical element 120 may be dielectric-coated to include a dielectric coating layer. More specifically, the dielectric coating layer of the first optical element 120 may be formed on a surface facing the second optical element 130, but is not limited thereto. The first optical element 120 may be dielectric-coated to adjust the reflectance of the first optical element 120. The dielectric coating is a type of coating made of an electrical insulator material and is a coating for obtaining a specific reflectance in a specific wavelength region. Since the dielectric coating layer is formed on the first optical element 120, the dielectric coating layer may be coated on the dielectric coating layer, and even when light is incident at a small incident angle, the reflection angle may be increased, thereby increasing light efficiency.

Transmission and reflectance may vary according to the thickness of the dielectric coating coated on the first optical element 120.

The transmission of the dielectric coating layer may vary depending on the incident angle. The reflectance and the transmittance are determined according to the angle, and the light incident on the dielectric coating layer may be reflected or transmitted according to the incident angle.

For example, the dielectric coating layer may be, but is not limited to, a dielectric coating that may include thin layers of materials such as magnesium, calcium fluoride, and various metal oxides. By selection of the composition, thickness, and number of these layers, the reflectance and transmittance of the coating can be tuned.

That is, the surface of the first optical element 120 may be coated with a dielectric material, and the reflectance and transmittance of the first optical element 120 may be adjusted by the dielectric coating.

The dielectric coating may form a plurality of dielectric layers, and the refractive index of the dielectric coating or the refractive index of sub-layers in the plurality of dielectric coatings and the order of the dielectric layers may also be adjusted. The increase in transmittance can reduce the overall reflectance, and increase or decrease the thickness of the dielectric layers to adjust the reflectance and transmittance of the coating.

The thickness of the dielectric layer of the side surface through which the first light L1 generated and incident from the light generating unit 110 is incident and transmitted to the first optical element 120 may be different from the thickness of the dielectric layer of the side surface through which the fifth light L5 reflected by the light guide 101 is incident to the first optical element 120. Since the dielectric layers are different from each other, reflectivity and transmittance may be different from each other, and the thickness of the dielectric coating may be adjusted to facilitate transmission and reflection according to an incident angle.

The first optical element 120 may be dielectric-coated and may transmit the first light L1 generated and incident from the light generating unit 110 according to an angle at which it is incident on the first optical element, and the fifth light L5 reflected by the light guide 101 and incident on the first optical element 120 may be reflected toward the user's eye 1.

Also, the first optical element 120 may be included with an inclination in a predetermined direction. The first optical element 120 may be inclined in a predetermined direction to transmit the first light L1 generated by the light generating unit 110 and incident at a predetermined incident angle, and the fifth light L5 reflected by the light guide 101 may be incident at a predetermined incident angle and reflected toward the user's eye 1.

The optical device for augmented reality 10 may include a light guide 101. The light guide 101 may be made of a material that is transmitted or reflected according to an incident angle, but is not limited thereto. The light guide 101 may reflect the second light L2 transmitted through the first optical element 120 in a predetermined direction.

A second optical element 130 that reflects the third light L3 reflected by the light guide 101 may be included. The second optical element 130 may reflect the third light L3 reflected and incident from the light guide 101 to be incident on the light guide 101 at a predetermined angle, and the light guide 101 may allow the fifth light L5 reflecting the fourth light L4 reflected and incident from the second optical element 130 to be incident on the first optical element 120 at a predetermined angle.

In addition, the reflective surface of the second optical element 130 may be disposed to be inclined toward the light guide 101. The second optical element 130 may be disposed to be inclined toward the light guide 101 to reflect the third light L3 reflected from the light guide 101 and incident thereon, and the fourth light L4 in which the third light L3 is reflected from the second optical element 130 may be incident on the light guide 101.

Fourth light L4 may be incident on the light guide 101 by being reflected from the second optical element 130, and fifth light L5, which is incident on the fourth light L4 and is reflected from the light guide 101, may be incident on the first optical element 130 in a predetermined direction and be reflected therefrom. The fifth light L5 incident on the first optical element 120 may be emitted to the user's eye 1 to implement the augmented reality and be incident on the user's eye 1.

More specifically, the first light L may be emitted from the light generating unit 110 of the optical device for augmented reality 10, and the first light L2 emitted from the light generating unit 110 may pass through the first optical element 120. The second light L, which is transmitted through the first optical element, may be incident on the light guide 101. The second light L2 may be incident on the light guide 101 to be reflected, and the third light L3, which is the second light L2 reflected by the light guide 101, may be reflected by the second optical element 130. The third light L3 may be reflected by the light guide 101, the third light L3 may be reflected by the light guide 101 to be incident on the second optical element 130, and the fourth light L4 that is reflected by the second optical element 130 may be incident on the light guide 101. The fifth light, in which the fourth light L4 is reflected by the light guide 101, is incident on the first optical element 120 at a predetermined incident angle, is reflected toward the user's eye 1, and is incident on the user's eye 1, thereby implementing augmented reality.

The optical device for augmented reality 10 may include an optical unit 100. The optical unit 100 may perform a function of transmitting light emitted from an object in the real world and emitting light reflected by the first optical element 120 to the user's eye 1.

In the optical unit, the light guide 101, the first optical element 120, and the second optical element 130 may be embedded and included, but may be included in the optical device for augmented reality 10 according to the selection of the skilled person in the art. The optical unit may transmit the real image light to the user's eyes.

As illustrated in FIG. 3, when the first light L1 is emitted from the light generating unit 110, the first light L1 may be transmitted through the first optical element 120, and the first light L1 may be incident and the second light L2 transmitted through the first optical element 120 may be incident on the light guide 101. The second light L2 may be reflected by the light guide 101, and the third light L3, which is the second light L2 reflected by the light guide 101, may be incident on the second optical element 130. The third light L3 may be reflected by the second optical element 130, and the fourth light L4 that is reflected by the second optical element 130 after the third light L3 is incident may be incident on the light guide 101. Fifth light L5 obtained by reflecting the fourth light L4 to the light guide 101 may be incident on the first optical element 120 at a predetermined incident angle, and the fifth light L5 may be incident on the first optical element 120) at the predetermined incident angle, reflected by the first optical element 120, and reflected toward the user's eye 1, thereby implementing augmented reality.

An incident angle at which the first light L1 is incident on the first optical element 120 may be a first incident angle θ1, and an incident angle at which the fifth light is incident on the first optical element 120 may be a second incident angle θ2.

Preferably, a first incident angle θ1 at which the first light L1 is incident on the first optical element 120 may be greater than 0° and less than 45°, and a second incident angle θ2 at which the fifth light L5 is incident on the first optical element 120 may be greater than 0° and less than 45°, and may be incident on the first optical element 120.

In addition, the first incident angle θ1 may be incident at an angle lower than the second incident angle θ2.

The first incident angle θ1 may be incident on the first optical element 120 at an angle lower than the second incident angle θ2 to be transmitted without being reflected by the first optical element 120, and the second incident angle θ2 may be incident at a larger angle to be reflected by the light guide 101 to be incident on the first optical element 120 without being transmitted to be reflected to be incident on the user's eyes, thereby implementing augmented reality.

An optical device for augmented reality 10 according to an exemplary embodiment of the present invention includes a light generating unit 110 generating a first light L1, a first optical element 120 transmitting the first light L1, a light guide 101 on which the first light L1 is incident and on which a second light L2 transmitted by the first optical element 120 is incident, and which reflects the second light L2, and a second optical element 130 on which the second light L2 is incident and on which a third light L3 reflected by the light guide 101 is incident, and which reflects the third light L3, and in which a fourth light L4 incident on and reflected by the second optical element 130 is incident on the light guide 101, and a fifth light L5, which is the fourth light L4 incident on the light guide 101 and reflected therefrom, is incident on the first optical element 120 and reflected toward the user's eye 1, thereby implementing an augmented reality, so that the thickness and structure of the optical device for augmented reality 10 may be simplified to improve the atomness of the optical device and provide an optical device for augmented reality that is easily manufactured.

The exemplary embodiment of the present invention is not necessarily limited to the above-described exemplary embodiment, and it will be apparent that various modifications and implementation within an equivalent range by those skilled in the art to which the present invention belongs are possible. Therefore, the true scope of the present invention is defined by the following claims.

### CODE DESCRIPTION

1: User's eyes
10: an Optical device for augmented reality
100: an Optical unit
101: a Light guide
110: a Light generating unit
120: a First optical element
130: a Second optical element

1. An optical device for augmented reality comprising:
a light generating unit configured to generate a first light;
a first optical element configured to transmit or reflect an incident light according to an incident angle;
a light guide configured to reflect the incident light; and
a second optical element comprising a predetermined slope and configured to reflect the incident light,
wherein a second light, which is the first light incident on and transmitted through the first optical element, is incident on the light guide,
wherein a third light, which is the second light incident on and reflected by the light guide, is incident on the second optical element,
wherein a fourth light, which is the third light incident on and reflected by the second optical element, is incident on the light guide,
wherein a fifth light, which is the fourth light incident on and reflected by the light guide, is incident on the first optical element, and
wherein a fifth light, which is the first optical element, is reflected and incident on user's eyes.

2. The optical device for augmented reality according to claim 1, wherein the first optical element includes a coating layer.

3. The optical device for augmented reality according to claim 1, wherein an incident angle at which the first light is incident on the first optical element is smaller than an incident angle at which the fifth light is incident on the first optical element.

4. The optical device for augmented reality according to claim 1, wherein an incident angle at which the first light is incident on the first optical element is in a range of 0° to 45°.

5. The optical device for augmented reality according to claim 1, wherein an incident angle at which the fifth light is incident on the first optical element is in a range of 0° to 45°.

6. The optical device for augmented reality according to claim 1, wherein the first optical element is obliquely included such that the first light is incident on and transmitted through first the optical element at a predetermined incident angle and the fifth light is incident on and reflected by the first optical element at a predetermined incident angle.

7. The optical device for augmented reality according to claim 1, wherein the second optical element is obliquely included such that the third light is reflected and is incident on the light guide.
